(19) United States
(12) Patent Application Publication
(10) Pub. No.: US 2022/0107475 A1
(43) Pub. Date: Apr. 7, 2022

(54) METHOD OF MANUFACTURING OPTICAL MODULE AND OPTICAL MODULE

(71) Applicant: Sumitomo Electric Industries, Ltd., Osaka-shi (JP)

(72) Inventors: Kenichi NAKAYAMA, Osaka-shi (JP); Masanobu Kawamura, Osaka-shi (JP)

(73) Assignee: Sumitomo Electric Industries, Ltd., Osaka-shi (JP)

(21) Appl. No.: 17/488,957

(22) Filed: Sep. 29, 2021

(30) Foreign Application Priority Data
Oct. 2, 2020 (JP) 2020-168018

(51) Int. Cl. G02B 6/42

(52) U.S. Cl. CPC G02B 6/4239; G02B 6/4295; G02B 6/426; G02B 6/4245

(57) ABSTRACT

A method of manufacturing an optical module is provided. The optical module includes an optical block having two positioning projections, a substrate, an optical element, and a positioning frame formed of a material having a coefficient of linear expansion that differs from that of the substrate. The positioning frame having two sides, positioning holes, and narrow portions, the positioning holes and the narrow portions being provided at the two sides. The method includes fixing the positioning frame on the substrate by a heat-curable adhesive provided at a portion excluding the positioning holes and the narrow portions, mounting the optical element on the substrate, press-fitting the two positioning projections of the optical block into the two positioning holes of the positioning frame, and fixing the optical block, the positioning frame, and the substrate to each other.

### CROSS REFERENCE TO RELATED APPLICATIONS

This application claims priority based on Japanese Patent Application No. 2020-168018 filed on Oct. 2, 2020, and the entire contents of the Japanese patent application are incorporated herein by reference.

### TECHNICAL FIELD

The present disclosure relates to a method of manufacturing an optical module and an optical module.

### BACKGROUND

In recent years, optical receiving modules used in optical transceivers and the like are used for transmissions at 40 Gbps and 100 Gbps with demands for higher communication speeds. In such high-speed transmissions, a wavelength multiplexed light in which a plurality of signal lights having wavelengths different from each other are wavelength-multiplexed is often used. For example, in an optical receiving module disclosed in JP-A-2014-137436, various optical components and optical receiving elements are mounted in a package.

Further, in order to meet the demand for reduction in size and cost of an optical transceiver, JP-A-2004-246279 proposes an optical module having a structure in which optical components are disposed on one surface of a transparent substrate and optical elements are disposed on the other surface of the substrate so that no package is used.

### SUMMARY OF THE DISCLOSURE

In the optical module using the package described in JP-A-2014-137436, optical components such as an optical demultiplexer, a mirror, and a condenser lens provided in the package, and facilities for production including a complicated operation mechanism for optical alignments of the optical elements are used, and mass productivity is limited. In addition, in the optical module described in JP-A-2004-246279, in order to improve the accuracy of alignment between the lens and the optical device disposed with the transparent substrate interposed therebetween, it is necessary to improve the processing accuracy of an optical socket provided with the lens, and in order to improve the productivity, it is necessary to improve the workability of optical axis alignments.

The present disclosure has been made in view of these circumstances, and an object of the present disclosure is to provide a method of manufacturing an optical module and an optical module capable of accurately and easily performing optical axis alignments.

An optical module manufacturing method according to one aspect of the present disclosure includes an method of an optical module including an optical block having a light input-output surface and provided with two positioning projections on a side of the light input-output surface; a substrate on which an optical element is mounted; and a positioning frame formed of a material having a coefficient of linear expansion that differs from a coefficient of linear expansion of the substrate, the positioning frame having two sides that face each other via an opening portion, the positioning frame having positioning holes and narrow portions adjacent to the positioning holes, the positioning holes and the narrow portions being provided at the two sides to be symmetric with respect to the opening portion. The method includes fixing the positioning frame on the substrate by a heat-curable adhesive provided at a portion excluding the positioning holes and the narrow portions, mounting the optical element on the substrate by using, as a reference, the two positioning holes provided at the positioning frame, press-fitting the two positioning projections of the optical block into the two positioning holes of the positioning frame, and fixing the optical block, the positioning frame, and the substrate to each other.

An optical module according to another aspect of the present disclosure includes an optical block having a light input-output surface and provided with two positioning projections on a side of the light input-output surface; a substrate on which an optical element is mounted; and a positioning frame formed of a material having a coefficient of linear expansion that differs from a coefficient of linear expansion of the substrate, the positioning frame having two sides that face each other via an opening portion, the positioning frame having positioning holes and narrow portions adjacent to the positioning holes, the positioning hole and the narrow portion being provided of the two sides to be symmetric with respect to the opening portion. The positioning frame is fixed on the substrate by a heat-curable adhesive provided at a portion excluding the positioning holes and the narrow portions. The two positioning projections of the optical block are press-fitted into the two positioning holes of the positioning frame, and the two positioning holes and the two positioning projections are in contact with each other at a portion on a side of the opening portion and at a portion on a side opposite the opening portion, respectively.

### BRIEF DESCRIPTION OF THE DRAWINGS

FIG. 1 is a perspective view illustrating an example of an optical module according to an embodiment of the present disclosure.

FIG. 2 is an exploded perspective view of an optical module shown in FIG. 1.

FIG. 3 is a side view of an optical module shown in FIG. 1.

FIG. 4A is a cross-sectional view illustrating an optical block.

FIG. 4B is a side view illustrating the optical block.

FIG. 5 is a diagram illustrating a relationship between a substrate and a positioning frame.

FIG. 6 is a diagram illustrating an example of a flow of a method of manufacturing the optical module according to the present disclosure.

FIG. 7A is a diagram illustrating an example of a step of fixing the positioning frame to the substrate.

FIG. 7B is a diagram schematically illustrating an example of stresses acting on the positioning frame.

FIGS. 7C and 7D are diagrams illustrating an example of a relationship between a positioning hole of a substrate and a positioning projection of an optical block.

FIG. 8A is a diagram illustrating another example of a step of fixing the positioning frame to a substrate.

FIG. 8B is a diagram schematically illustrating another example of stresses acting on the positioning frame.

FIGS. 8C and 8D are diagrams illustrating another example of a relationship between the positioning hole of the substrate and the positioning projection of the optical block.

### DETAILED DESCRIPTION OF EMBODIMENTS OF THE INVENTION

First, embodiments of the present disclosure will be listed and described.

(1) A method of manufacturing an optical module according to the present disclosure includes an method of an optical module includes including an optical block having a light input-output surface and provided with two positioning projections on a side of the light input-output surface; a substrate on which an optical element is mounted; and a positioning frame formed of a material having a coefficient of linear expansion that differs from a coefficient of linear expansion of the substrate, the positioning frame having two sides that face each other via an opening portion, the positioning frame having positioning holes and narrow portions adjacent to the positioning holes, the positioning hole and the narrow portion being provided at each of the two sides to be symmetric with respect to the opening portion. The method includes fixing the positioning frame on the substrate by a heat-curable adhesive provided at a portion excluding the positioning holes and the narrow portions, mounting the optical element on the substrate by using, as a reference, the two positioning holes provided at the positioning frame, press-fitting the two positioning projections of the optical block into the two positioning holes of the positioning frame, and fixing the optical block, the positioning frame, and the substrate to each other.

In this method of manufacturing an optical module, a distance between the positioning holes before the positioning frame is fixed on the substrate is differ from that after the positioning frame is fixed on the substrate due to the difference in linear expansion coefficients between the substrate and the positioning frame. However, since the positioning holes are provided symmetrically with respect to the opening portion, the straight line connecting the positioning holes does not change before and after the fixing. Therefore, two positioning holes can be used as a reference, and the optical element can be easily positioned when mounted on the substrate. In addition, when the positioning projections provided on the optical block is press-fitted to the positioning holes of the positioning frame, since the interval of the positioning hole has been changed, the positioning projections and the positioning holes come into contact with each other at the opening portion side of the positioning frame or at the opposite side of the opening portion, respectively, and thus it is possible to suppress the influence on the positioning accuracy due to the influence of the manufacturing tolerance of the positioning holes and the positioning projections. In the present disclosure, the optical element means a light receiving element or a light emitting element.

(2) In the method of manufacturing the optical module according to the present disclosure, one of the positioning holes has a circular cross-sectional shape having a first diameter and corresponding one of the positioning projections has a circular cross-sectional shape having a second diameter which may be smaller than the first diameter. Thus, the accuracy of the diameter of the positioning hole and the allowable range of the diameter of the positioning projection can be increased.

(3) In the method of manufacturing the optical module according to the present disclosure, the coefficient of linear expansion of the positioning frame may be larger than the coefficient of linear expansion of the substrate. Thus, when the heat-curable adhesive is cured at a high temperature and then returns to room temperature, a tensile stress acts on the positioning frame, so that the interval between the positioning holes provided in the positioning frame can be changed.

(4) In the method of manufacturing the optical module according to the present disclosure, the positioning frame may contain resin, and the substrate may contain polyimide. Thus, a material having heat resistance, mechanical characteristics, flame retardancy, chemical resistance, electrical characteristics, and the like can be used for the positioning frame, and an insulating material having high mechanical strength, heat resistance, and flame retardancy can be used for the substrate.

(5) In the method of manufacturing the optical module according to the present disclosure, in the fixing, the positioning frame is fixed to the substrate with the heat-curable adhesive with the heat-curable temperature which may be higher than or equal to 80° C. and lower than or equal to 180° C. Thus, the positioning frame can be fixed on the substrate without affecting the characteristics of the substrate and a printed wiring provided on the substrate.

(6) In the method of manufacturing the optical module according to the present disclosure, in the fixing, t, an ultraviolet-curable adhesive may be applied between the optical block, the positioning frame, and the substrate and then the ultraviolet-curable adhesive is irradiated with ultraviolet ray. Thus, since the optical block, the positioning frame, and the substrate can be fixed without applying heat, the positioning accuracy between members is not affected by heating.

(7) An optical module according to the present disclosure includes an optical block having a light input-output surface and provided with two positioning projections on a side of the light input-output surface; a substrate on which an optical element is mounted; and a positioning frame formed of a material having a coefficient of linear expansion that differs from a coefficient of linear expansion of the substrate, the positioning frame having two sides that face each other via an opening portion, the positioning frame having positioning holes and narrow portions adjacent to the positioning hole, the positioning hole and the narrow portion being provided at each of the two sides to be symmetric with respect to the opening portion. The positioning frame is fixed on the substrate by a heat-curable adhesive provided at a portion excluding the positioning holes and the narrow portions. The two positioning projections of the optical block are press-fitted into the two positioning holes of the positioning frame, and the two positioning holes and the two positioning projections are in contact with each other at a portion on a side of the opening portion and at a portion on a side opposite the opening portion, respectively.

In the optical module, the optical element can be positioned with reference to two positioning holes provided in the positioning frame. In addition, since the two positioning holes provided in the positioning frame and the two positioning projections provided in the optical block are in contact with each other at the opening portion side of the positioning frame or at the opposite side of the opening portion, the positioning accuracy of the optical block with respect to the frame is improved.

(8) In the optical module according to the present disclosure, the optical block, the positioning frame, and the substrate may be fixed to each other by an ultraviolet-curable adhesive. Thus, the optical module having high mechanical strength can be obtained.

(9) In the optical module according to the present disclosure, one of the positioning holes has a circular cross-sectional shape having a first diameter and corresponding one of the positioning projections may have a circular cross-sectional shape having a second diameter which may be smaller than the first diameter. Thus, the accuracy of the diameter of the positioning hole and the allowable range of the diameter of the positioning projection can be increased.

(10) In the optical module according to the present disclosure, the coefficient of linear expansion of the positioning frame may be larger than the coefficient of linear expansion of the substrate. When the positioning frame is fixed to the substrate using the heat-curable adhesive at the time of manufacturing, a tensile stress acts on the positioning frame at the time of returning from a high temperature to room temperature. Thus, it is possible to change the interval between the positioning holes provided in the positioning frame.

(11) In the optical module according to the present disclosure, the positioning frame may contain resin, and the substrate may contain polyimide. This improves the heat resistance, mechanical properties, flame retardancy, and chemical resistance of the positioning frame, and also improves the mechanical strength, heat resistance, and flame retardancy of the substrate.

(12) In the optical module according to the present disclosure, the narrow portions provided at the two sides of the positioning frame are each formed by a concave portion provided on a side of the opening portion of the positioning frame. Thus, when the positioning frame is fixed to the substrate using the heat-curable adhesive in manufacturing, the interval between the positioning holes provided in the positioning frame can be largely changed by the tensile stress acting on the positioning frame when the temperature returns from a high temperature to room temperature.

(13) In the optical module according to the present disclosure, the optical element mounted on the substrate may be positioned at the opening portion of the positioning frame. Thus, the size of the optical module can be reduced.

A method of manufacturing an optical module and a specific example of an optical module according to the present disclosure will be described below with reference to the drawings. The present invention is not limited to the following examples, but is defined by the scope of the claims, and is intended to include all modifications within the meaning and scope equivalent to the scope of the claims. Further, as long as a plurality of embodiments can be combined, the present invention includes a combination of any embodiments. In the following description, components denoted by the same reference numerals in different drawings are the same, and a description thereof may be omitted.

### First Embodiment

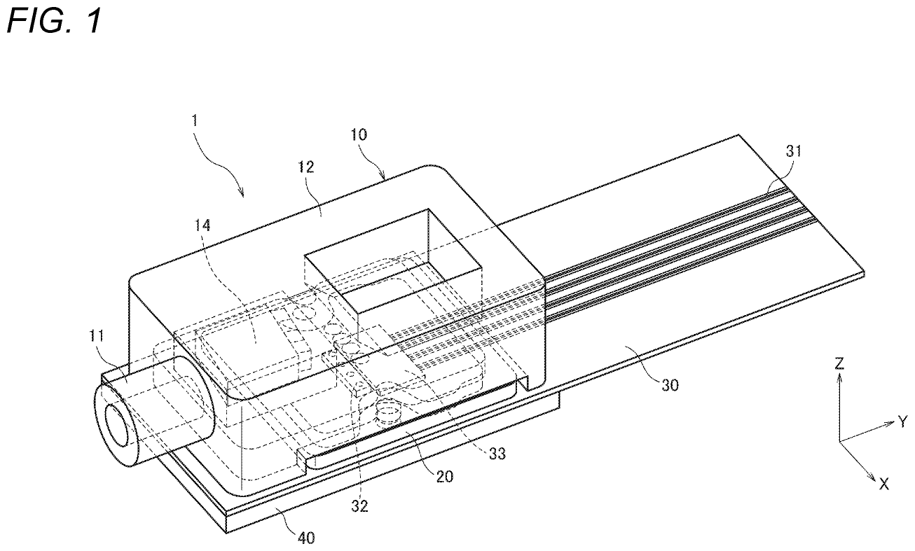

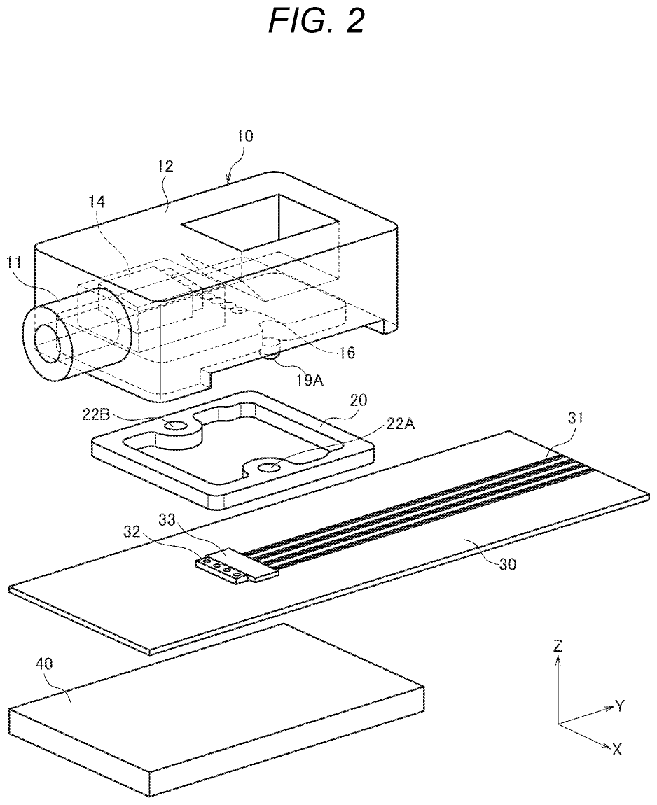

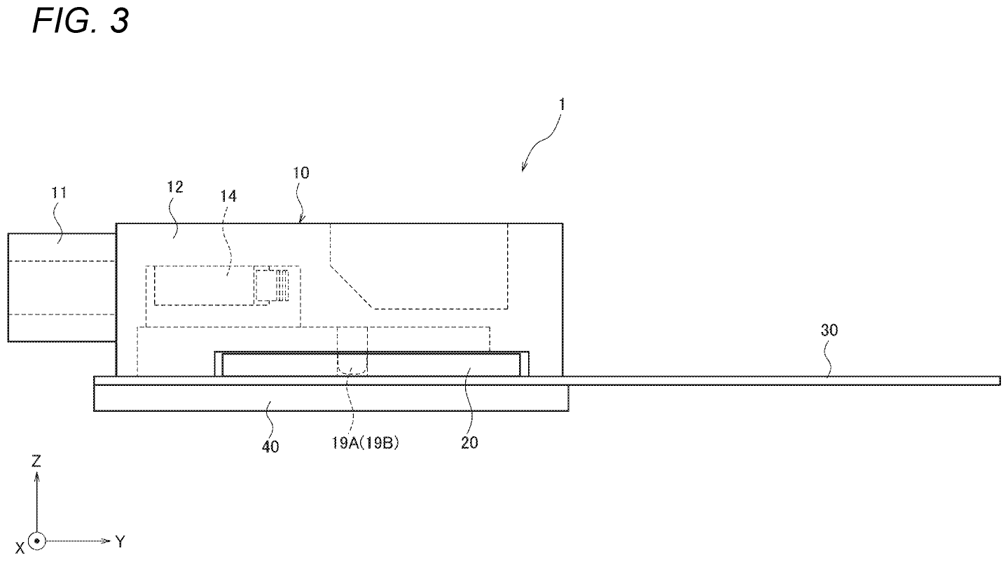

In the following description, an optical receiving module will be described as an example of an optical module. The optical module receives a multiplexed optical signal in which a plurality of signal lights having different wavelengths are multiplexed, demultiplexes the multiplexed optical signal into respective signal lights by an optical demultiplexer, and then converts the respective signal lights into electric signals FIG. 1 is a perspective view illustrating an example of an optical module according to an embodiment of the present disclosure, and is a view illustrating a configuration of the optical module manufactured according to the present disclosure. FIG. 2 is an exploded perspective view of the optical module shown in FIG. 1, and FIG. 3 is a side view of the optical module shown in

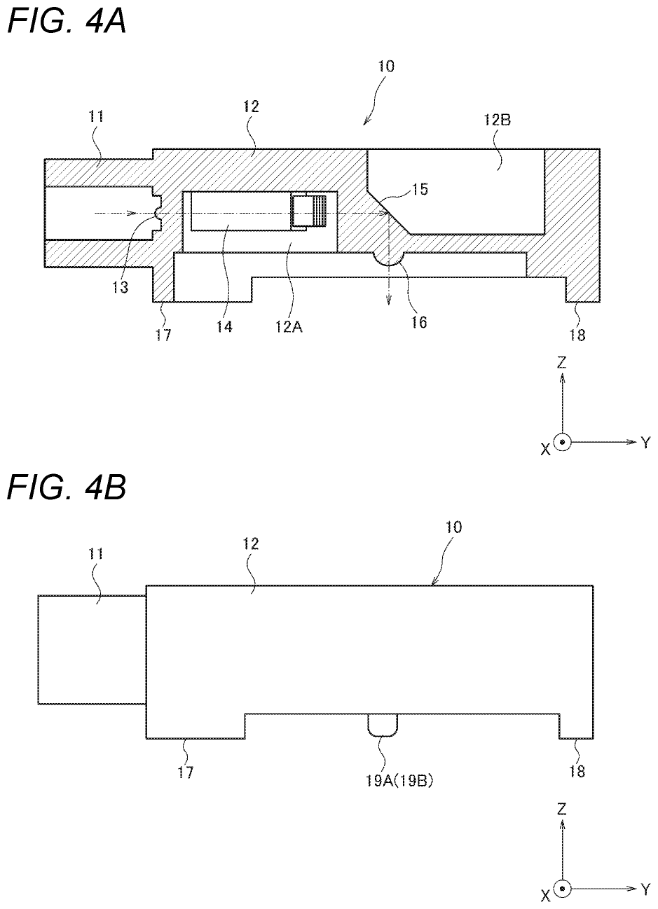

FIG. 1. FIG. 4A is a cross-sectional view of an optical block, and FIG. 4B is a side view of the optical block.

An optical module 1 of the present embodiment includes an optical block 10 on which optical components are mounted, a positioning frame 20, an FPC (flexible printed circuit board, hereinafter referred to as “printed circuit board”) 30 on which an optical element 32 and a TIA (transimpedance amplifier) 33 are mounted, and a reinforcing substrate 40. As shown in FIG. 4A, the optical block 10 includes a sleeve portion 11 for housing a stub (not shown) containing an optical fiber, and a body portion 12. The optical block 10 is integrally formed of a resin material optically transparent to the signal light received from the optical fiber. The body portion 12 includes a first recess 12A, a second recess 12B, a first lens 13, a reflective surface 15, and a second lens 16. A printed circuit board 30 corresponds to the substrate of the present disclosure, and the final product of the optical module may include the reinforcing substrate 40 for reinforcing the printed circuit board 30.

In the following description, a direction from the sleeve portion 11 toward the first lens 13 may be referred to as a Y-axis direction, a direction orthogonal to the Y-axis in a plane parallel to the printed circuit board 30 may be referred to as an X-axis direction, and a direction orthogonal to the X-axis and the Y-axis may be referred to as a Z-axis direction. The positive and negative directions of each axis are as shown in each figure.

The first recess 12A is a recess for housing and placing an optical demultiplexer 14. The optical demultiplexer 14 is placed in the first recess 12A while being aligned with incident light from the first lens 13. When the optical demultiplexer 14 is housed in the first recess 12A, the optical demultiplexer 14 may be fitted into the first recess 12A. For example, the optical demultiplexer 14 may be positioned with respect to the optical block 10 by being held at the outer side surface of the optical demultiplexer 14 with a projection or the like provided on the first recess 12A. The second recess 12B is a recess for forming the reflective surface 15. A stub containing an optical fiber (not shown) is to be fitted into the sleeve portion 11 and the optical fiber is positioned with respect to the optical block 10. In the present embodiment, the sleeve portion 11 and the optical block 10 are integrally formed, but may be separately formed. In this case, the sleeve portion 11 may be made of a metal material including SUS (iron (Fe), chromium (Cr), and nickel (Ni) alloy).

A multiplexed optical signal emitted from the optical fiber (not shown) travels toward the first lens 13 located in the positive direction of the Y-axis as indicated by the dashed-dotted arrow in FIG. 4A, is converted into collimated light by the first lens 13, and then enters the optical demultiplexer 14. The optical demultiplexer 14 is an optical component for demultiplexing a plurality of, for example, four signal lights included in the multiplexed optical signal into signal lights each having a single wavelength, and includes one reflecting member and a plurality of wavelength division filters. The signal light demultiplexed into four different single wavelengths by the optical demultiplexer 14 is emitted in the positive direction of the Y-axis at a predetermined interval in the X-axis direction, enters the optical block 10, and then the traveling direction of the signal light is changed by approximately 90 degrees by the reflective surface 15, and the signal light is emitted in the negative direction of the Z-axis.

The second lens 16 is formed on the reflective surface 15 in the negative Z-axis direction. The second lens 16 is provided for each of the four signal lights demultiplexed by the optical demultiplexer 14, and includes four lenses provided at predetermined intervals in the X-axis direction. The second lens 16 functions as a condenser lens that receives one of the four signal lights reflected by the reflective surface 15, and condense the signal light on the optical element 32 formed of PDs (photo diodes) mounted on the printed circuit board 30 (for example, see FIG. 1). The second lens 16 provided in the optical block 10 corresponds to the light input-output surface of the present disclosure.

As shown in FIG. 2, the printed circuit board 30 is provided with a printed wiring 31. The optical element 32 and the TIA 33 are mounted thereon. In this embodiment, as the optical element 32, four PDs are arranged as a PD array in the X-axis direction as a receiving optical element. The four signal lights emitted from the second lens 16 are converted into electric signals by the respective PDs including the optical element 32, and the electric signals are amplified by the TIA 33.

In the present embodiment, as described later, the signal light emitted from the optical block 10 is input into the optical element 32 mounted on the printed circuit board 30 without performing optical alignment between the optical block 10 and the optical element 32. Therefore, in the present embodiment, as shown in FIG. 2, two positioning projections 19A and 19B are provided in on a side of the light input-output surface is provided, and a positioning frame 20 having positioning holes 22A and 22B is used, so that a positional relation in the X-Y direction between the second lens 16 and the optical element 32 are adjusted. The second lens 16 and the optical element 32 are positioned in the Z-axis direction by setting the distance in the Z-axis direction between the second lens 16 and mounting surfaces 17 and 18 of the optical block 10 which come in touch with the printed circuit board 30 in advance.

The positioning projections 19A and 19B are provided at both ends of the optical block 10 in the X-axis direction. Each of the positioning projections 19A and 19B is a projection having a circular cross section, and a tip portion thereof may be tapered. The two positioning projections 19A and 19B are provided along the X-axis direction such that a line connecting the centers of the positioning projections 19A and 19B is parallel with a line connecting the centers of the lenses of the second lens 16. The line connecting the centers of the positioning projections 19A and 19B may coincide with a line connecting the centers of the lenses of the second lens 16. Lengths of the positioning projections 19A and 19B are set so as not to protrude in the negative direction of the Z-axis from the mounting surfaces 17 and 18 of the optical block 10.

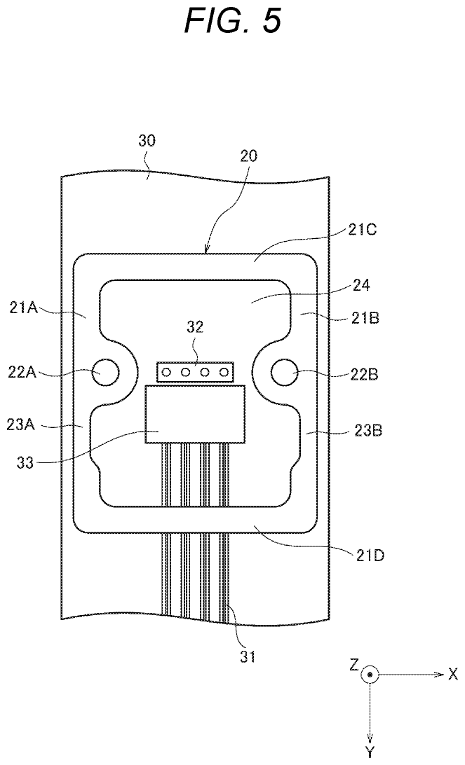

Next, the positioning frame 20 will be described. FIG. 5 is a diagram illustrating the relationship between the printed circuit board 30 and the positioning frame 20. As shown in FIG. 5, the positioning frame 20 of the present embodiment is formed of a substantially rectangular frame body having two sides 21A and 21B facing each other via an opening portion 24 and sides 21C and 21D orthogonal to these sides 21A and 21B. In the two sides 21A and 21B, positioning holes 22A and 22B are provided at positions so that the positioning holes 22A and 22B face the positioning projections 19A and 19B provided in the optical block 10, respectively, and narrow portions 23A and 23B are provided adjacent to the positioning holes 22A and 22B, respectively.

The positioning holes 22A and 22B are holes for the positioning projections 19A and 19B of the optical block 10 to be press-fitted. In the present embodiment, the positioning holes 22A and 22B are provided at positions where the sides 21A and 21B protrude toward the opening portion 24. Each of the positioning holes 22A and 22B has a circular cross section in an X-Y plane, and a straight line connecting the centers of the positioning holes 22A and 22B extends along the X-axis direction, which is a direction orthogonal to the sides 21A and 21B. The positions of the centers of the positioning holes 22A and 22B and the positions of the positioning projections 19A and 19B are set so that a distance between the centers of the positioning holes 22A and 22B is equal to a distance between the centers of the positioning projections 19A and 19B.

The narrow portions 23A and 23B are portions formed to be narrower than other portions of the sides, and promote deformation of the narrow portions 23A and 23B due to stresses acting on the sides 21A and 21B in a fixing step of the positioning frame 20 and the printed circuit board 30 described later. In the present embodiment, concave portions are provided on opening portion sides of the sides 21A and 21B to form the narrow portions 23A and 23B. As shown in FIG. 5, the positioning holes 22A, 22B and the narrow portions 23A, 23B formed on the sides 21A, 21B are respectively symmetrical with respect to the opening portion 24. That is, they are symmetrical with respect to a center line of the positioning frame 20 extending along the sides 21A and 21B.

As shown in FIG. 1, FIG. 2 or FIG. 5, the printed circuit board 30 is provided with a copper-made printed wiring 31 on a surface of the printed circuit board. The optical element 32 and the TIA 33 are mounted at the position of the opening portion 24 of the positioning frame 20. In this embodiment, the positioning frame 20 is made of a material having a linear expansion coefficient larger than that of the material of the printed circuit board 30. For example, copper is used as a material of the printed wiring 31, polyimide is used as a base material of the printed circuit board 30 for the printed circuit board 30. As a material of the positioning frame 20, resin having a larger linear expansion coefficient than that of copper or polyimide is used for the positioning frame 20. Ultem which is a resin made of Poly Ether (PEI) may be used as the resin for the positioning frame 20. Ultem is a registered trademark of SABIC. Here, the linear thermal expansion coefficient of copper and polyimide is about 20 ppm/° C., and the linear thermal expansion coefficient of Ultem is about 50 ppm/° C. Polyimide is an insulating material having high mechanical strength, excellent heat resistance and flame retardancy, and Ultem is excellent in heat resistance, mechanical properties, flame retardancy, chemical resistance, electrical properties, and the like.

### Manufacturing Method

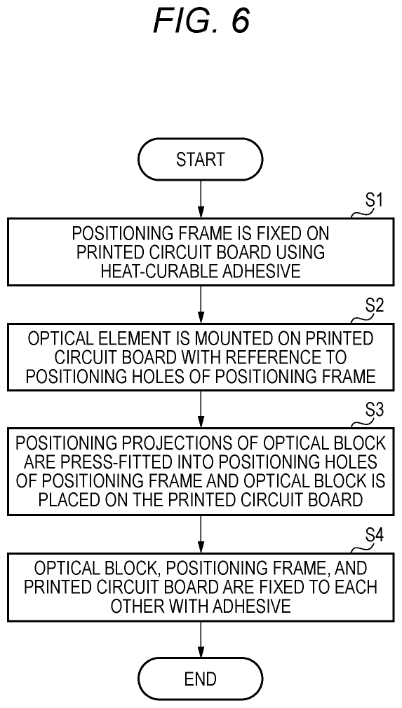

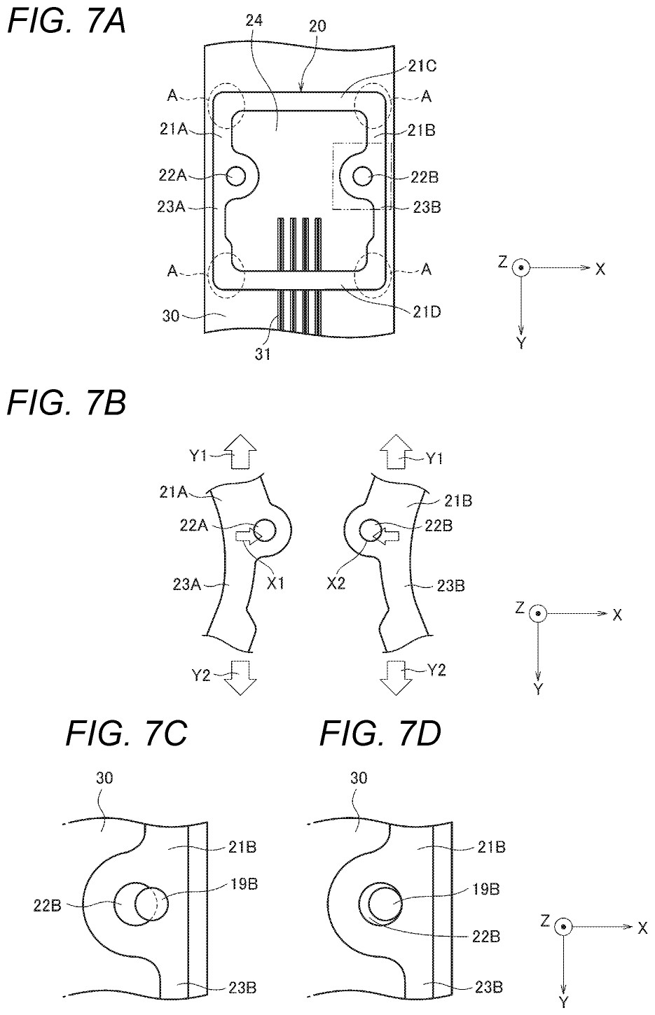

FIG. 6 is a diagram illustrating an example of a flow of a method of manufacturing an optical module according to the present disclosure. FIG. 7A is a diagram illustrating an example of a step of fixing the positioning frame 20 to the printed circuit board 30, and FIG. 7B is a diagram schematically illustrating stresses acting on the positioning frame 20. FIGS. 7C and 7D are enlarged views of a portion surrounded by two short dashes line in FIG. 7A, and are diagrams illustrating an example of the relationship between the positioning hole 22B of the positioning frame 20 and the positioning projection 19B of the optical block 10.

In manufacturing the optical module 1, it is assumed that the optical block 10 has been already resin-molded integrally, the optical demultiplexer 14 has been positioned and housed in the first recess 12A, and in this state, the first lens 13, the optical demultiplexer 14, the reflective surface 15, and the second lens 16 have been optically aligned. Similarly, the printed circuit board 30 is provided with the printed wiring of a predetermined pattern. Further, it is assumed that the distance between the positioning holes 22A and 22B of the positioning frame 20 is equal to the distance between the positioning projections 19A and 19B of the optical block 10.

Steps for manufacturing optical module 1 will be described according to the flow of FIG. 6 with reference to FIG. 7A to FIG. 7D. In a state in which the optical block 10, the positioning frame 20, and the printed circuit board 30 are prepared, the positioning frame 20 is fixed on the printed circuit board 30 using a heat-curable adhesive as shown in step S1 of FIG. 6. In this step, the heat-curable adhesive is not attached to the entire surface of the positioning frame 20, but the heat-curable adhesive is provided at portions excluding at least the positioning holes 22A, 22B and the narrow portions 23A, 23B. For example, the heat-curable adhesive is applied to each corner portion of the positioning frame 20 surrounded by a broken line A in FIG. 7A.

The positioning of the positioning frame 20 with respect to the pattern of the printed wiring 31 of the printed circuit board 30 does not require high accuracy. Therefore, it may be performed by using an image recognition device or by visual observation. In addition, a wiring serving as a marker for positioning may be formed on the printed circuit board 30 in advance.

As the heat-curable adhesive, for example, an epoxy resin is used, and the temperature for curing is in the range of 80° C. to 180° C.

After the heat-curable adhesive is cured at such a high temperature, the positioning frame 20 and the printed circuit board 30 are returned to room temperature. At this time, since the linear thermal expansion coefficient of the positioning frame 20 is larger than the linear thermal expansion coefficients of the printed circuit board 30 and the printed wiring 31, tensile stresses Y1 and Y2 act, during cooling to room temperature, on the sides 21A and 21B of the positioning frame 20 in the longitudinal direction (Y-axis direction) as shown in FIG. 7B. The positioning holes 22A, 22B and the narrow portions 23A, 23B are not bonded to the printed circuit board 30 because no heat-curable adhesive is provided. Since the narrow portions 23A and 23B are provided in the sides 21A and 21B, the portion of the side 21A where the positioning hole 22A is provided is deformed in the positive direction of the X-axis as indicated by the arrow X1, while the portion of side 21B where the positioning hole 22B is provided is deformed in the negative direction of the X-axis as indicated by the arrow X2.

Therefore, the distance between the positioning holes 22A and 22B provided in the positioning frame 20 becomes shorter compared to the distance before the positioning frame is bonded. However, since the positioning holes 22A, 22B and the narrow portions 23A, 23B provided in the positioning frame are provided symmetrically with respect to the center line parallel to the sides 21A and 21B, the distance between the positioning holes 22A and 22B shrinks along the X-axis, and the straight line connecting the positioning holes 22A and 22B hardly changes before and after the positioning frame 20 is bonded to the printed circuit board 30.

After the positioning frame 20 is bonded to the printed circuit board 30, the process proceeds to step S2 of FIG. 6, and the optical element 32 is mounted on the printed circuit board 30 with reference to the positioning holes 22A and 22B of the positioning frame 20. In particular, a mounting position of the optical element 32 is determined with an intermediate point connecting the positioning holes 22A and 22B as an origin. When the mounting position of the optical element 32 is determined with reference to the positioning holes 22A and 22B, a distance between the second lens 16 and the line connecting the positioning projections 19A and 19B provided in the optical block 10 is taken into consideration.

After the optical element 32 is mounted on the printed circuit board 30, the TIA 33 is mounted. After mounting the TIA 33, the process proceeds to step S3 shown in FIG. 6, and the positioning projections 19A and 19B of the optical block 10 are press-fitted into the positioning holes 22A and 22B of the positioning frame 20, respectively, and the optical block 10 is placed on the printed circuit board.

When the positioning projections 19A and 19B of the optical block 10 are press-fitted to the positioning holes 22A and 22B of the positioning frame 20, the distance between the positioning holes 22A and 22B is narrowed in the process of bonding the positioning frame 20 to the printed circuit board 30. Thus, the distance between the positioning holes 22A and 22B is smaller than the distance between the positioning projections 19A and 19B. Therefore, when the positioning projections 19A and 19B are press-fitted into the positioning holes 22A and 22B, as illustrated in FIG. 7C, in side 21B which is on the right side of the positioning frame 20, the outer wall of the positioning hole 22B may be positioned on the inner side, that is, closer to the opening portion 24, than the outer end of the positioning projection 19B.

However, by forming each of the distal ends of the positioning projections 19A and 19B into an appropriate tapered shape, the positioning frame 20 is expanded by press-fitting of the positioning projection 19B as illustrated in FIGS. 7C and 7D, and the positioning projection 19B is inserted into the positioning hole 22B in a state where the outer end of the positioning projection 19B and the outer wall of the positioning hole 22B are in contact with each other. The same applies to the positioning hole 22A of the side 21A on the left side of the positioning frame 20 and the positioning projection 19A of the optical block 10, and the positioning projection 19A is inserted into the positioning hole 22A in a state in which the outer end of the positioning projection 19A and the outer wall of the positioning hole 22A are in contact with each other. Since the narrow portions 23A and 23B provided in the sides 21A and 21B of the positioning frame 20 have shapes that are likely to cause elastic deformation, and have a function of facilitating insertion of the positioning projections 19A and 19B into the positioning holes 22A and 22B.

The positioning projections 19A and 19B are stably fixed in the positioning holes 22A and 22B, respectively, in a state in which each is stressed toward the opening portion side of the positioning frame 20, that is, in a state in which the second lens 16 is stressed toward the center line of the positioning frame 20. At this time, since the stresses acting on the positioning projections 19A and 19B are the same, the intermediate position between the positioning projections 19A and 19B serving as the center position of the second lens 16 is maintained at the intermediate position between the positioning holes 22A and 22B. Therefore, even if the diameters of the positioning holes 22A and 22B are larger than the diameters of the positioning projections 19A and 19B, the positioning projections 19A and 19B can be reliably and accurately positioned with respect to the positioning frame 20, and the optical axes of the second lens 16 and the optical element 32 can be accurately and easily aligned. When the optical block 10 and the positioning frame 20 are manufactured, the positioning holes 22A and 22B may have diameters, for example, 1.01 times or larger than those of the positioning projections 19A and 19B.

The positioning of the optical block 10 in the height direction (Z-axis direction) can be performed by pressing the optical block 10 toward the positioning frame 20 until the mounting surfaces 17 and 18 provided on the front and rear side of the optical block 10 in the Y-axis direction come into contact with the printed circuit board 30.

After the optical block 10 is placed on the printed circuit board 30, the process proceeds to step S4, in which the optical block 10, the positioning frame 20, and the printed circuit board 30 are fixed to each other with an adhesive. As the adhesive, an ultraviolet-curable adhesive is used, and after the ultraviolet-curable adhesive is applied to gaps between the optical block 10, the positioning frame 20, and the printed circuit board 30, the ultraviolet-curable adhesive is irradiated with ultraviolet rays, thereby they are bonded at room temperature. The fixing of the reinforcing substrate 40 may be performed at an appropriate stage after the step S3. In this case, it is desirable to perform the fixing at room temperature in order to avoid the influence of heat.

### Second Embodiment

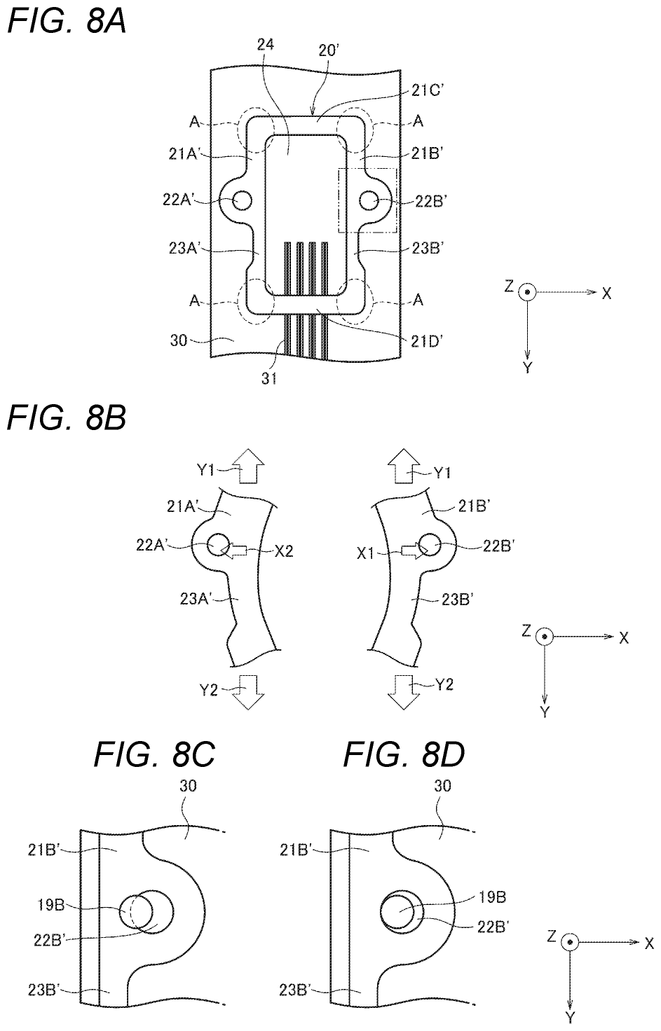

Next, the second embodiment will be described. FIG. 8A is a diagram illustrating another example of a step of fixing the positioning frame to the substrate. FIG. 8B is a diagram schematically illustrating another example of stresses acting on the positioning frame, and FIGS. 8C and 8D are diagrams illustrating another example of the relationship between the positioning hole of the substrate and the positioning projection of the optical block 10. In the second embodiment, the shape of a positioning frame 20′ is different from that of the positioning frame 20 of the first embodiment.

As shown in FIG. 8A, the positioning frame 20′ of the second embodiment is formed of a substantially rectangular frame body having two sides 21A′ and 21B′ facing each other via the opening portion 24 and sides 21C′ and 21D′ orthogonal to the sides 21A′ and 21B′. In the two sides 21A′ and 21B′, positioning holes 22A′ and 22B′ are provided at positions facing the positioning projections 19A and 19B provided on the optical block 10, and narrow portions 23A′ and 23B′ are provided adjacent to the positioning holes 22A′ and 22B′, respectively.

The positioning holes 22A′ and 22B′ are holes for the positioning projections 19A and 19B of the optical block 10 to be press-fitted, respectively. In the second embodiment, the positioning holes 22A′ and 22B′ are provided at positions where the sides 21A′ and 21B′ protrude toward the opposite side of the opening portion 24. Each of the positioning holes 22A′ and 22B′ has a circular cross section in the X-Y plane, and a straight line connecting the centers of the positioning holes 22A′ and 22B′ extends along the X-axis direction, which is a direction orthogonal to the sides 21A′ and 21B′. The positions of the centers of the positioning holes 22A′ and 22B′and positions of the positioning projections 19A′ and 19B′ are set so that a distance between the centers of the positioning holes 22A′ and 22B′ is equal to a distance between the centers of the positioning projections 19A and 19B.

The narrow portions 23A′ and 23B′ are portions formed to be narrower than the other portions of the sides, and promote deformation of the narrow portions 23A′ and 23B′ due to stresses acting on the sides 21A′ and 21B′ in a fixing of the positioning frame 20′ and the printed circuit board 30 described later. In the present embodiment, concave portion are provided on the other side to opening portion 24 in the sides 21A′ and 21B to form the narrow portions 23A′ and 23B′. As shown in FIG. 8A, the positioning holes 22A′, 22B′ and the narrow portions 23A′, 23B′ formed in the sides 21A′, 21B′, respectively, are symmetrical with respect to the opening portion 24. That is, they are symmetrical with respect to a center line of the positioning frame 20′ extending along the sides 21A and 21B′. Since the configuration other than the positioning frame 20′ is the same as that of the first embodiment, the description thereof will be omitted.

### Manufacturing Method

The method of manufacturing the optical module according to the second embodiment is the same as that of the first embodiment, and the optical module can be manufactured according to the same process as the flow shown in FIG. 6. However, in the second embodiment, the relationship between the stresses acting on the positioning projections 19A and 19B of the optical block 10 and the positioning holes 22A′ and 22B′ of the positioning frame 20′ in the step of fixing the positioning frame 20′ on the printed circuit board 30 using the heat-curable adhesive in the step S1 is different from that in the first embodiment.

In the fixing step of S1, a heat-curable adhesive is applied to portions excluding at least the positioning holes 22A′, 22B′ and the narrow portions 23A′, 23B′, cured at high temperature, and then returned to room temperature. At this time, since the linear thermal expansion coefficient of the positioning frame 20′ is larger than the linear thermal expansion coefficients of the printed circuit board 30 and the printed wiring 31, tensile stresses Y1 and Y2 act, during cooling to room temperature, on the sides 21A′ and 21B′ of the positioning frame 20′ in the longitudinal direction (Y-axis direction) as shown in FIG. 8B. Since portions at the positioning holes 22A′, 22B′ and the narrow portions 23A′, 23B′ are not provided with the heat-curable adhesive, the portion of the side 21A′ where the positioning hole 22A′ is provided is deformed in the negative direction of the X-axis as indicated by the arrow X2, while the position of side 21B′ where the positioning hole 22B′ is provided is deformed in the positive direction of the X-axis as indicated by the arrow X1. That is, the directions of the stresses acting on the positioning frame 20′ schematically shown in FIG. 8B are in a relationship in which the left and right sides are interchanged as compared with the case of the first embodiment shown in FIG. 7B.

Therefore, the distance between the positioning holes 22A′ and 22B′ provided in the positioning frame 20′ becomes longer compared to the distance before being bonded. However, since the positioning holes 22A′, 22B′ and the narrow portions 23A′, 23B′ provided in the positioning frame are provided symmetrically with respect to the center line parallel to the sides 21A′ and 21B′, the distance between the positioning holes 22A′ and 22B′ extends along the X-axis, and the straight line connecting the positioning holes 22A′ and 22B′ hardly changes before and after the positioning frame 20′ is bonded to the printed circuit board 30.

In the step S3, when the positioning projections 19A and 19B of the optical block 10 are press-fitted to the positioning holes 22A′ and 22B′ of the positioning frame 20′, the distance between the positioning holes 22A′ and 22B′ is larger than the distance between the positioning projections 19A and 19B. Therefore, when the positioning projections 19A and 19B of the optical block 10 are press-fitted to the positioning holes 22A′ and 22B′, regarding side 21B′, the positioning frame 20′ is contracted by the press-fitting of the positioning projection 19B, and the positioning projection 19B is inserted into the positioning hole 22B′ in a state where the inner end of the positioning projection 19B and the inner wall of the positioning hole 22B′ are in contact with each other, as shown in FIGS. 8C and 8D.

This also applies to the positioning hole 22A′ of the side 21A′ on the left side of the positioning frame 20′ and the positioning projection 19A of the optical block 10, and the positioning projection 19A is inserted into the positioning hole 22A′ in a state where the inner end of the positioning projection 19A is in contact with the inner wall of the positioning hole 22A′. Since the narrow portions 23A′ and 23B′ provided in the sides 21A′ and 21B′ of the positioning frame 20′ also have shapes that are likely to cause elastic deformation, and have a function of facilitating insertion of the positioning projections 19A and 19B into the positioning holes 22A′ and 22B′.

The positioning projections 19A and 19B are stably fixed in the positioning holes 22A′ and the 22B′, respectively, in a state of being stressed toward a direction away from the center line of the positioning frame 20′, that is, in a state in which the second lens 16 is stressed in an extending direction. As described above, in the second embodiment, although the directions of the stresses acting between the positioning projections 19A, 19B and the positioning holes 22A′ and 22B′ are opposite to those in the first embodiment, the positioning projections 19A and 19B can be reliably and accurately positioned with respect to the positioning frame 20′, and the optical axes of the second lens 16 can be accurately and easily aligned with the optical element 32.

Although an example of a receiver optical sub-assembly (ROSA) that is an optical receiving module having a light receiving element as an optical element has been described above as an optical module, the content of the present disclosure is applicable not only to the ROSA but also to a transmitter optical sub-assembly (TOSA) having a light emitting element as an optical module.

What is claimed is:

1. A method of manufacturing an optical module comprising:
an optical block having a light input-output surface and provided with two positioning projections on a side of the light input-output surface;
a substrate on which an optical element is mounted; and
a positioning frame formed of a material having a coefficient of linear expansion that differs from a coefficient of linear expansion of the substrate, the positioning frame having two sides that face each other via an opening portion, the positioning frame having positioning holes and narrow portions adjacent to the positioning holes, the positioning holes and the narrow portions being provided at the two sides to be symmetric with respect to the opening portion,
wherein the method comprises:
fixing the positioning frame on the substrate by a heat-curable adhesive provided at a portion excluding the positioning holes and the narrow portions;
mounting the optical element on the substrate by using, as a reference, the two positioning holes provided at the positioning frame;
press-fitting the two positioning projections of the optical block into the two positioning holes of the positioning frame; and
fixing the optical block, the positioning frame, and the substrate to each other.

2. The method of manufacturing the optical module according to claim 1, wherein one of the positioning holes has a circular cross-sectional shape having a first diameter and corresponding one of the positioning projections has a circular cross-sectional shape having a second diameter which is smaller than the first diameter.

3. The method of manufacturing the optical module according to claim 1, wherein the coefficient of linear expansion of the positioning frame is larger than the coefficient of linear expansion of the substrate.

4. The method of manufacturing the optical module according to claim 1, wherein the positioning frame contains resin, and the substrate contains polyimide.

5. The method of manufacturing the optical module according to claim 1, wherein, in the fixing, the positioning frame is fixed to the substrate with the heat-curable adhesive at a treatment temperature higher than or equal to 80° C. and lower than or equal to 180° C.

6. The method of manufacturing the optical module according to claim 1, wherein, in the fixing, an ultraviolet-curable adhesive is applied between the optical block, the positioning frame, and the substrate and then the ultraviolet-curable adhesive is irradiated with ultraviolet ray.

7. An optical module comprising:
an optical block having a light input-output surface and provided with two positioning projections on a side of the light input-output surface;
a substrate on which an optical element is mounted; and
a positioning frame formed of a material having a coefficient of linear expansion that differs from a coefficient of linear expansion of the substrate, the positioning frame having two sides that face each other via an opening portion, the positioning frame having positioning holes and narrow portions adjacent to the positioning holes, the positioning holes and the narrow portions being provided of the two sides to be symmetric with respect to the opening portion,
wherein the positioning frame is fixed on the substrate by a heat-curable adhesive provided at a portion excluding the positioning holes and the narrow portions, and
wherein the two positioning projections of the optical block are press-fitted into the two positioning holes of the positioning frame, and the two positioning holes and the two positioning projections are in contact with each other at a portion on a side of the opening portion and at a portion on a side opposite the opening portion, respectively.

8. The optical module according to claim 7, wherein the optical block, the positioning frame, and the substrate are fixed to each other by an ultraviolet-curable adhesive.

9. The optical module according to claim 7, wherein one the positioning holes has a circular cross-sectional shape having a first diameter and corresponding one of the positioning projections has a circular cross-sectional shape having a second diameter which is smaller than the first diameter.

10. The optical module according to claim 7, wherein the coefficient of linear expansion of the positioning frame is larger than he coefficient of linear expansion of the substrate.

11. The optical module according to claim 7, wherein the positioning frame contains resin, and the substrate contains polyimide.

12. The optical module according to claim 7, wherein the narrow portions provided at the two sides of the positioning frame are each formed by a concave portion provided on a side of the opening portion of the positioning frame.

13. The optical module according to claim 7, wherein the optical element mounted on the substrate is positioned at the opening portion of the positioning frame.
